(19) United States
(12) Patent Application Publication
(10) Pub. No.: US 2007/0195954 A1
(43) Pub. Date: Aug. 23, 2007

(54) Image forming apparatus for printing security documents by duplex printing and method thereof

(75) Inventors: Mi-Jung Jang, Suwon-si (KR); Kyeong-Man Kim, Suwon-si (KR); Hyun-Soo Oh, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/384,312

(22) Filed: Mar. 21, 2006

(30) Foreign Application Priority Data
Sep. 26, 2005 (KR) 2005-89478

(51) Int. Cl. G09C 3/08

(52) U.S. Cl. 380/51

(57) ABSTRACT

An image forming apparatus printing a security document by duplex printing and a method thereof are provided. The image forming apparatus comprises a terminal device interface unit receiving a printing command for printing a printable code data from an exterior terminal device, a printing engine unit printing the code data onto a paper, and a control unit, if the printing command is for printing a security mark data on a rear page of the paper, controlling the printing engine unit to print the security mark data onto the rear page of the paper. Accordingly, the security mark is printed on the rear page of the paper so that the security document can be printed.

### CROSS-REFERENCED TO RELATED APPLICATIONS

This application claims the benefit under 35 U.S.C. § 119(a) of Korean Patent Application No. 2005-89478, filed on Sep. 26, 2005, the entire disclosure of which is hereby incorporated by reference.

### BACKGROUND OF THE INVENTION

1. Field of the Invention

The present invention relates to an image forming apparatus for printing security documents by duplex printing, and method thereof. More particularly, the present invention relates to an image forming apparatus for printing security documents by duplex printing, which prints a security mark over the rear page of printed paper to denote a security document when the security document is printed, and a method thereof.

2. Description of the Related Art

Today, increasing amounts of sensitive and confidential information is handled by companies. Maintaining the confidentiality of this information continues to be a major problem. Companies must employ creative techniques and methods to safeguard the security of this information.

If a confidential document is printed, kept and used, it may be necessary to indicate that the printed document is a security document. Conventionally, the security mark is inserted onto a front page of the printed paper to serve as an indication that the printed document is a security document.

FIGS. 1A and 1B are views of sample security documents printed from a conventional image forming apparatus.

Referring to FIG. 1A, a security mark 20 is printed on a space where the print data is not printed, such as, on an upper portion of the right side of a document 10. The security mark 20 is an indication that the printed document 10 is a security document. However, if the space printed with security mark 20 is inadvertently or maliciously damaged, it may be impossible to know that the printed document 10 is a security document.

Referring to FIG. 1B, the security mark 20 is printed on the printed page of the document 10. However, the security mark 20 covers the print data so that the content of document 10 may not be recognized.

Accordingly, there is a need for an improved system and method for providing protection to a space printed with a security mark so that the integrity of the security document is maintained despite the possibility of damage.

### SUMMARY OF THE INVENTION

An aspect of exemplary embodiments of the present invention is to address at least the above problem and/or disadvantages and to provide at least the advantages described below. Accordingly, an aspect of exemplary embodiments of the present invention is to provide an image forming apparatus and method capable of employing duplex printing to print a security mark over a rear page of printed paper to indicate that the printed document is a security document.

To achieve the above-described object, an image forming apparatus including: a terminal device interface unit, a printing engine unit, and a control unit is provided. The terminal device interface unit receives a printing command for printing a printable code data from an exterior terminal device. The printing engine unit prints the code data onto a paper. The control unit controls the printing engine unit to print the security mark data onto the rear page of the paper if the printing command is for printing the security mark data on a rear page of the paper.

The control unit may control the printing engine unit to repeatedly print the security mark data so as to arrange the security mark data in a chessboard pattern over the rear page of the paper.

The apparatus may further comprise a storage unit for storing the security mark data. The control unit may further receive an update command for adding and deleting the security mark data stored in the storage unit through the terminal device interface unit from the terminal device.

To achieve the above-described object, a terminal device is provided including: an application program unit executing an application program that generates print data to be printed in an exterior image forming apparatus, and a driver unit converting the print data into a printable code data and generating a printing command for printing security mark data on a rear page of a paper to be printed with the code data.

To achieve the above-described object, a method is provided for printing a security document including: receiving a printing command for printing a printable code data onto a paper, if the printing command is for printing a security mark data on a rear page of the paper printed with the code data and printing the security mark data onto the rear page of the paper.

The step of printing the security mark data may be repeated so as to arrange the security mark data in a chessboard pattern over the rear page of the paper.

The method may further include storing the security mark data and receiving the printing command which may further receive an update command for adding and deleting the security mark data. For example, the method may further include receiving an update command to add and delete the stored security mark data.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing certain embodiments of the present invention with reference to the accompanying drawings, in which:

FIGS. 1A and 1B are views of security documents printed from a conventional image forming apparatus.

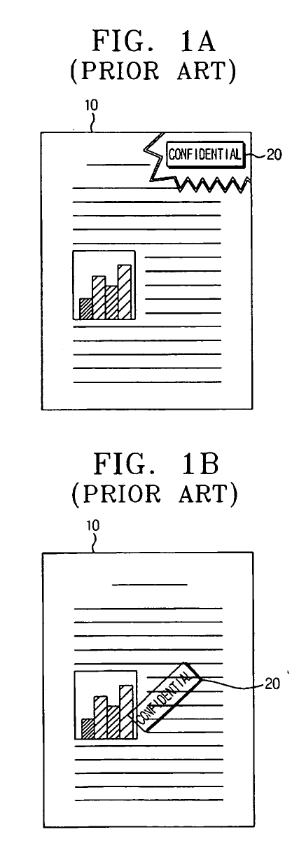

FIG. 2 is a schematic view of a construction of an image forming apparatus according to an exemplary embodiment of the present invention;

FIG. 3 is a view of a driver window of a terminal device corresponding to an image forming apparatus according to an exemplary embodiment of the present invention; and

FIG. 4 is a flowchart provided for explaining an operation of an image forming apparatus according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for conciseness and clarity.

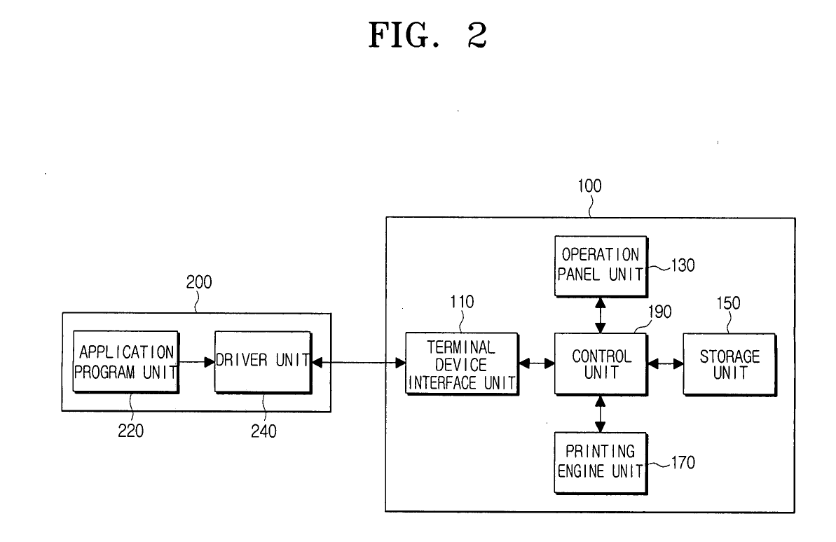

FIG. 2 is a schematic view of construction of an image forming apparatus according to an exemplary embodiment of the present invention.

Referring to FIG. 2, an image forming apparatus 100 communicates with a terminal device 200 to print the print data generated by the terminal device 200 onto paper.

The terminal device 200 comprises an application program unit 220 for generating and editing the print data and a driver unit 240 for converting the generated print data into code data such as PCL 5e, PCL XL, and PDL readable by the image forming apparatus 100.

As a user inputs a printing command through a driver window (not shown) generated by the driver unit 240, the driver unit 240 transmits the printing command together with the converted code data to the image forming apparatus 100 corresponding to the driver unit 240.

The image forming apparatus 100 comprises a terminal device interface unit 110, an operation panel unit 130, a storage unit 150, a printing engine unit 170 and a control unit 190.

The terminal device interface unit 110 receives the code data and printing command from the driver unit 240 to transmit to the control unit 190.

The operation panel unit 130 comprises a plurality of operation keys (not shown) capable of receiving various commands from a user and a display window (not shown) for displaying status information according to operations of the image forming apparatus 100 to control the image forming apparatus 100.

The storage unit 150 stores a control program for controlling functions of the image forming apparatus 100 and stores a font for printing. The storage part also temporarily stores the code data such as PCL 5e, PCL XL, and PDL transmitted from the terminal device 200.

Additionally, the storage unit 150 stores the security mark data for setting a security mark function. An authorized user can generate the security mark data as a text character or an image by using various application programs in the terminal device 200. The generated security data may be added to the storage unit 150 or deleted from the storage unit 150 if necessary.

The printing engine unit 170 receives the bit-map data generated from the control unit 190 under the control of the control unit 190 and prints the bit-map data together with the security mark data of the storage unit 150 onto the paper. The printing engine unit 170 prints the bit-map data onto a front page of the paper and prints the security mark data over the entire rear page of the printed paper in a chessboard pattern.

The control unit 190 converts the code data of the storage unit 150 into bit-map data. The control unit 190 additionally controls the printing engine unit 170 to print the security mark data over the whole rear page of paper printed with the bit-map data.

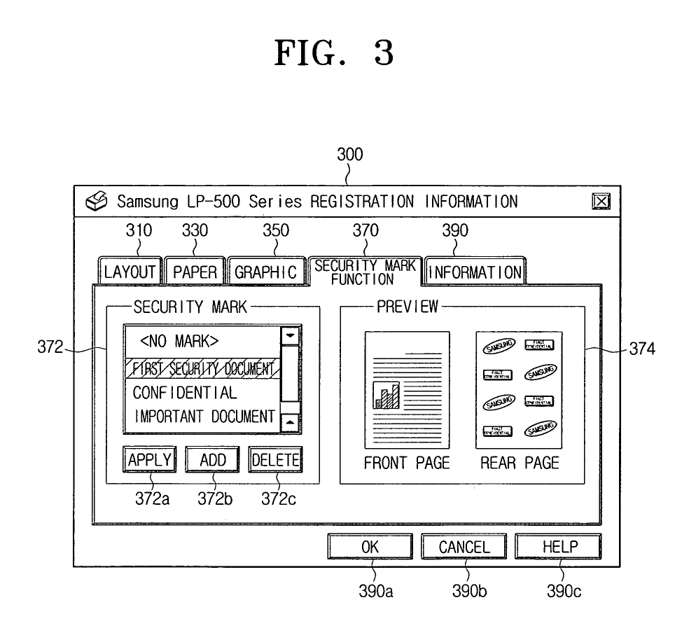

FIG. 3 is a view of an example of a driver window of a terminal device corresponding to the image forming apparatus according to an exemplary embodiment of the present invention.

The driver window 300 of FIG. 3 is available to an authorized user capable of controlling the image forming apparatus. The driver window 300 corresponding to the image forming apparatus 100 comprises a layout setting window 310 setting a layout of the paper; a paper setting window 330 setting a kind of paper and a paper cassette; a graphic setting window 350 setting a watermark; an information display window 390 displaying information on the driver and a security mark function setting window 370 setting a security mark function.

The layout setting window 310, the paper setting window 330, the graphic setting window 350, and the information display window 390 can be set by a general user, and the security mark function setting window 370 can be set only by the authorized user.

In FIG. 3, the security mark function setting window 370 is shown in detail. The security mark function setting window 370 comprises a security mark selection window 372, a front page printing property setting window 376, a rear page printing property setting window 278, and a preview window 374.

The security mark selection window 372 selects the type of security mark data. An ‘apply’ button 372a is pressed after the type of security mark data is selected. Subsequently, the selected security mark data is displayed on the preview window 374. If a general user prints the security document, the selected security mark data will be printed on the rear page of the paper.

An ‘add’ button 372b updates the security mark data stored in the image forming apparatus 100. As the ‘add’ button 372b is clicked, a user can store the security mark data generated through the application program in the storage unit 150. As a ‘delete’ button 372c is clicked, the security mark data stored in the storage unit 150 can be deleted.

As an ‘OK’ button 390a is selected, the paper is printed with the set security mark data. As a ‘cancel’ button 390b is pressed, the set security mark data is canceled. By clicking a ‘help’ button 390c, the explanation on the driver window 300 can be seen.

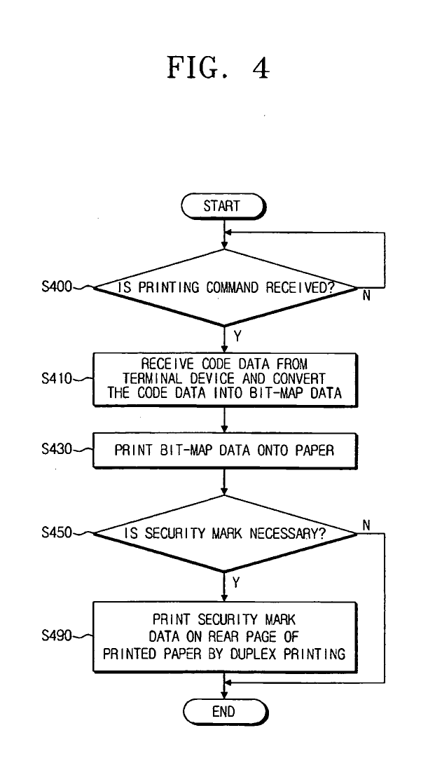

FIG. 4 is a flowchart provided for explaining an operation of an image forming apparatus according to an exemplary embodiment of the present invention.

Referring to FIG. 4, the control unit 190 determines if the printing command is received. For example, the control unit 190 determines if the code data and printing command are received through the terminal device interface unit 110 from the terminal device 200 (S400). The code data is converted from the print data and the printing command is on the print data.

The control unit 190 receives the code data from the terminal device 200 to convert it into the bit-map data. For example, the control unit 190 converts the code data, received with the printing command through the terminal device interface unit 110, into the printable bit-map data (S410).

The converted bit-map data is printed onto the paper (S430), and then, the control unit 190 determines if the security mark is necessary for the bit-map data (S450).

If the control unit 190 determines that the security mark is necessary for the bit-map data, the security mark data is printed onto a rear page of the printed paper using duplex printing. The control unit 190 controls the printing engine unit 170 to repeatedly print the security mark data over the entire rear page of the printed paper in a chessboard pattern (S490).

The above method allows the security mark to be printed over the whole rear page of the paper.

As described above, according to an exemplary embodiment of the present invention, the security mark is printed over the whole rear page of the paper using duplex printing. Therefore, any question that may arise relating to the status of a document as a security document can be prevented if any subsequent damage to the security mark occurs. Also, damage to the document content resulting from the existence of the security mark can be prevented.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming apparatus comprising:
a terminal device interface unit for receiving a printing command for printing a printable code data from an exterior terminal device;
a printing engine unit for printing the code data onto a paper; and
a control unit for controlling the printing engine unit to print the security mark data onto the rear page of the paper, if the printing command is for printing a security mark data on a rear page of the paper.

2. The apparatus as claimed in claim 1, wherein the control unit controls the printing engine unit to repeatedly print the security mark data whereby the security mark data is arranged in a chessboard pattern over the rear page of the paper.

3. The apparatus as claimed in claim 1, further comprising:
a storage unit for storing the security mark data,
wherein the control unit further receives an update command for adding and deleting the security mark data through the terminal device interface unit from the terminal device to add and delete the security mark data stored in the storage unit.

4. A terminal device comprising:
an application program unit for executing an application program that generates print data to be printed in an exterior image forming apparatus; and
a driver unit for converting the print data into a printable code data and generating a printing command for printing a security mark data on a rear page of a paper to be printed with the code data.

5. A method for printing a security document comprising:
receiving a printing command for printing a printable code data onto a paper; and
printing the security mark data onto the rear page of the paper if the printing command is for printing a security mark data on a rear page of the paper printed with the code data.

6. The method as claimed in claim 5, wherein the step of printing the security mark data repeatedly prints the security mark data whereby the security mark data is arranged in a chessboard pattern over the rear page of the paper.

7. The method as claimed in claim 5, further comprising:
storing the security mark data,
wherein the step of receiving the printing command further receives an update command for adding and deleting the security mark data to add and delete the stored security mark data.
